(19) United States
(12) Patent Application Publication
(10) Pub. No.: US 2003/0034713 A1
(43) Pub. Date: Feb. 20, 2003

(54) Supplemental electric power generator and system

(76) Inventor: Warren D. Weber, Edmonds, WA (US)

Correspondence Address: Dean A. Craine, DEAN A. CRAINE, P.S., Suite 140, 400 112th Avenue NE, Bellevue, WA, 98004-5542, US

(21) Appl. No.: 10/224,110

(22) Filed: Aug. 19, 2002

Related U.S. Application Data
(60) Provisional application No. 60/313,870, filed on Aug. 20, 2001.

(51) Int. Cl. H02N 1/00

(52) U.S. Cl. 310/309

(57) ABSTRACT

A supplemental electric power generator and system used to produce electrical energy using the magnetic flux produced by high power electric transmission lines. The generator is hung from a guide wire extended parallel to a suspended high power transmission line. Each generator includes a hollow body made of non-conductive material with an upper end cap and a lower end cap. Disposed longitudinally inside the body is a phosphorescent tube that illuminates when placed within the magnetic flux produced by electricity flowing through the high power transmission line. Located around the phosphorescence tube is a plurality of inward facing photo voltaic cells. When electricity flows through the high power transmission lines, the phosphorescent tube is illuminated which produces electric currents in the photo voltaic cells and then transmitted to the main collection line. Each photo voltaic cell and generator includes transformers and regulators to control the flow of electricity and connection to other generators.

This is a utility patent application based on a provisional patent application (Serial No. 60/313,870) filed on Aug. 20, 2001.

### BACKGROUND OF THE INVENTION

1. Field of the Invention

This invention pertains to supplemental electrical power generators, and more particularly, to supplemental electrical power generators that derive their power to produce energy from wasted or unused energy systems.

2. Description of the Related Art

New methods to generate and conserve electrical energy are needed. Unfortunately, most engineers and scientists are focusing on new technologies for answers and solutions that cost billions of dollars to develop and implement. New methods to generate and conserve electrical energy that use old technology and that could be easily implemented would be especially desirable.

It is well known that a magnetic field is produced around a wire that carries an electric current. The strength of the magnetic field, known as magnetic induction or magnetic flux density, is symbolized as B and is be expressed by the following equation:

B=F/qv×sin 0 (where F is the force of the field, q is the electric charge, and v is the velocity)

Millions of miles of high power transmission lines have been assembled around the world to carry electricity from hydroelectric dams, coal-generated power plants, natural gas power plants, and nuclear power plants to local power companies and business. Over the last seventy-five years, concerns have been raised regarding the impacts these plants have on the environment. Recently, concerns have also been raised regarding the health affects to animals by the magnetic flux produced by high power transmission lines. Although the proof that harmful effects do occur is controversial, several (i.e. U.S. Pat. Nos. 4,474,676; 4,785,136; and 5,365,115) have been granted which disclose devices designed to reduce the interference and health effects of magnetic flux by high power transmission lines. No one appears to be developing technology that uses the magnetic flux to produce energy.

It is well known that when a fluorescent bulb is disposed in the magnetic flux created by an alternating electric current, phosphorescence occurs. Fluorescent bulbs are enclosed glass tubes filled with vapor, with a thin layer of phosphor containing material disposed on the inside surface. When an electric current is applied to the bulb electrodes, the mercury atoms are excited to a higher energy level. When the atoms return to a lower energy level, they give off energy which is absorbed by the phosphor containing material to provide illumination. When a fluorescent bulb is disposed in a magnetic flux created by an alternating electric current, the phosphor containing material located therein also undergoes phosphorescence. This phosphorescence will continue indefinitely as long as the electric current is maintained and the glass tube remains unbroken and filled with mercury vapor.

### SUMMARY OF THE INVENTION

It is an object of the present invention to provide a supplemental electrical power generator and system that efficiently produces electricity.

It is another object of the present invention to provide such a generator and system that uses the wasted or unused energy from existing technologies and components.

It is another object of the present invention to provide such a generator that is relatively inexpensive and easy to implement.

These and other objects of the invention which will become apparent are met by an electrical power generator and system used to convert the currently wasted electromagnetic field energy produced by the alternating electric current conducted along an existing high power transmission line into useful electricity. The generator is designed to be hung with a plurality of other identical generators from guide lines located immediately adjacent to an existing high power transmission line. In the preferred embodiment, the body is cylindrical in shape. It should be understood, however, that the body could be square or polygonal in cross-section. Each generator includes an elongated body with two end caps. The upper end cap includes an attachment means that securely attaches the body in a vertical, perpendicularly aligned position from the guide line that extends parallel to the high power transmission line. The lower end cap is designed to be selectively removed from the body so that a maintenance operator may gain access to the inner cavity formed inside each body. The lower end cap also contains an optional attachment means that enables the lower end cap to attach to a lower guide line located below and parallel to the upper guide line or to the upper guide line to orient the body horizontally.

Disposed longitudinally inside the body inner cavity is a phosphorescent tube similar to a standard fluorescent tube. The phosphorescent tube extends substantially the entire length of the body and undergoes phosphorescence when placed in close proximity to the magnetic flux created by the alternating electric current flowing through the nearby high power transmission line. When the body is assembled and hung from the upper and lower guide lines, the phosphorescent tube is in close proximity to the high power transmission line, so that the magnetic flux created by the alternating electric current causes phosphorescence.

Disposed inside the body and around the phosphorescent tube is a plurality of photo voltaic cells used to convert the light energy into electricity. In the preferred embodiment, the photo voltaic cells are assembled on first set of removable panels longitudinally aligned inside the body and radially disposed around the phosphorescent tube. The longitudinal edges of the panels are aligned and registered to form an enclosing cylindrical structure centered inside the body that completely surrounds the phosphorescent tube. During operation, the photo voltaic cells on each panel face inward to capture the light energy produced by the phosphorescent tube when exposed to the magnetic flux. Each photo voltaic cell or panel includes an internal transformer or voltage regulator so that a constant flow of alternating electric current is produced when capturing light energy. Each photo voltaic cell also includes a diode that keeps the flow of electricity in one direction.

In the preferred embodiment, the photo voltaic cells in each first set of panels are connected together in a series. Each panel includes the terminal electrical contacts that connect to terminal contacts located on a main junction box located inside each generator. External wires are used to connect each main junction box to a supplemental collection transmission line that runs parallel to the upper guide line. Disposed between the main junction box and the collection transmission line is an optional main voltage regulator that controls the flow of electricity between the main junction box and the supplemental collection transmission line.

Located inside each body is an optional second set of panels each with a plurality of photo voltaic cells attached thereto. The second set of panels is longitudinally aligned and registered inside the body to form an enclosing structure outside the first set of panels. The individual cells on the second set of panels face outward and generate electrical power from ambient light. The cells on each second set of panels include an internal transformer and voltage regulator attached to terminals located on the main junction box.

The generator is designed to be easily connected and disconnected from the guide lines and the collection transmission line so that it may be replaced and remanufactured. The phosphorescent tube and first and second sets of panels are also designed to slide longitudinally inside the body and lock and unlock in position thereto.

An optional indicator may be mounted on the side of each generator which informs an operator that the generator is functioning properly. In the event that the generator is broken or inactive, the bulb or sets of panels may be easily replaced or the entire generator may be easily removed and replaced with another generator.

The body should be made from a non-electrically conductive material (such as some form of plastic). This material must not be UV sensitive and must be able to withstand long exposures to the elements regardless of the season or weather conditions. It may be made of transparent material when the generator includes shelves with outer photo voltaic cells. When the second set of panels is not used, the body may be made of opaque, non-conductive material.

A major advantage of the generator is that no other source of energy is required to produce voltage and it can be used with existing high power transmission lines. It can also be easily modified to produce either D.C. or A.C. The method and apparatus does not produce particulate matter pollutants and has a minimum thermal signature.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto

### BRIEF DESCRIPTION OF THE DRAWINGS

FIG. 1 is a perspective view of a section of high power transmission lines with a plurality of supplemental electrical power generators hung from guide wires located adjacent to the high power transmission lines.

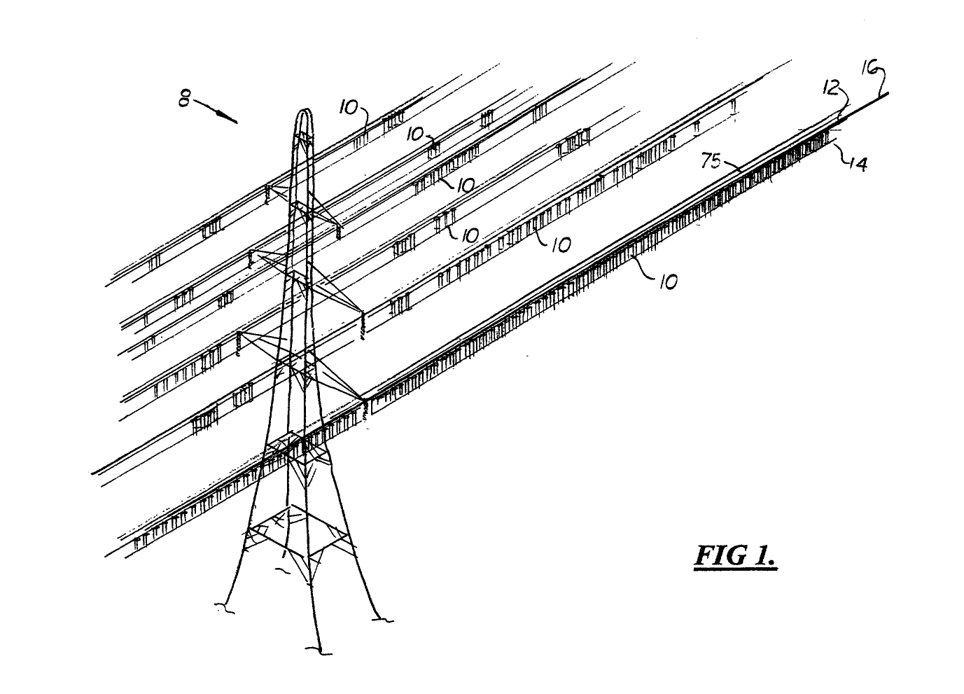

FIG. 2 is a side elevational view of two generators hung between two guide wires adjacent to a high power transmission line.

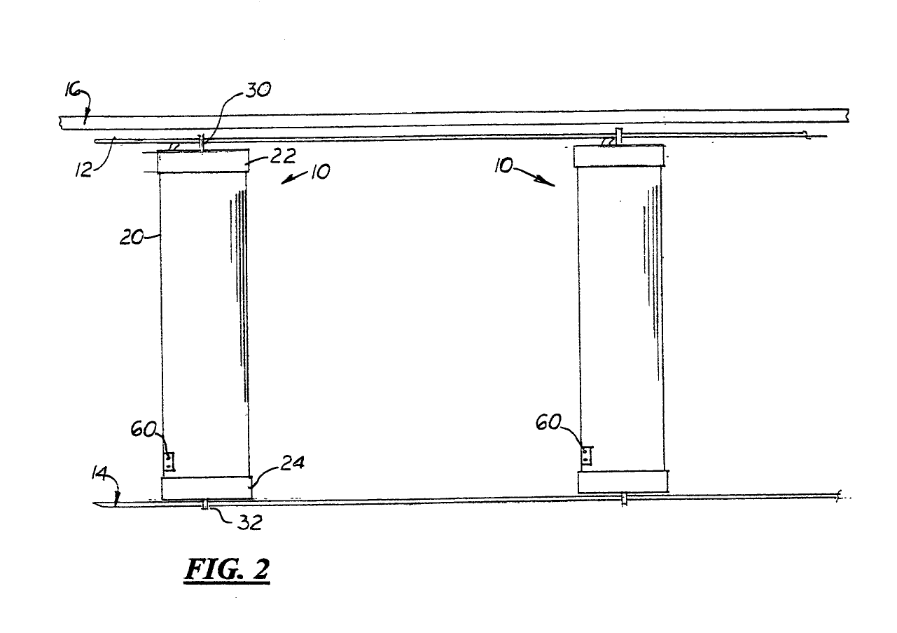

FIG. 3 is a sectional, side elevational view of one power generator.

FIG. 4 is a top plan view of the power generator shown in FIG. 3.

FIG. 5 is an electrical schematic of the power generator disclosed herein.

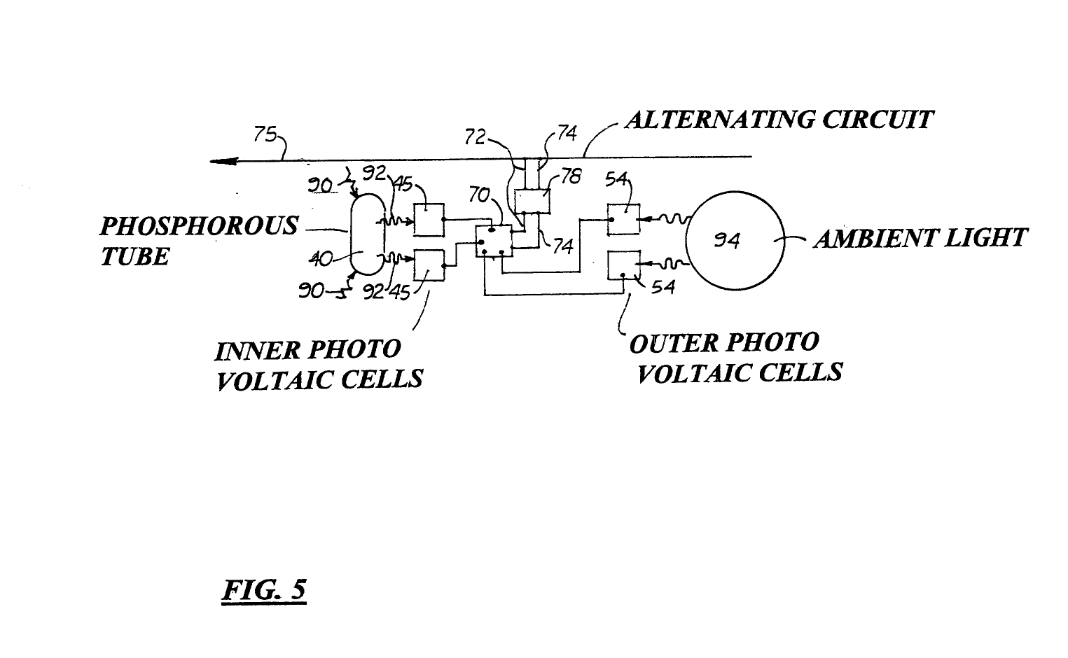

### DESCRIPTION OF THE PREFERRED EMBODIMENT(S)

Referring to the accompanying Figs., there is shown and described a system 8 for converting the energy in the electromagnetic field, produced by the electric current conducted along an existing high power transmission line 16 (three lines 16 shown), into electricity.

The system 8 uses a plurality of generators 10 designed to be hung from guide lines 12, 14 located immediately adjacent to a high power transmission lines 16. In the preferred embodiment, each generator 10 includes an elongated hollow tube or body 20 with an inner cavity 26 and two end caps 22, 24. The upper end cap 22 includes an attachment means 30 that securely attaches the body 20 in a vertical, perpendicularly aligned position to the upper guide line 12. The lower end cap 24 is designed to be selectively removed from the body 20 so that a maintenance operator may gain access to the inner cavity 26. The lower end cap 24 also contains an optional attachment means 32 that enables it to attach either to a lower guide line 14 located below and parallel to the upper guide line 12 or to the upper guide line 12 thus enabling the body 20 to be held horizontally adjacent to the transmission line 16 (not shown). In the preferred embodiment, the body 20 is made from a non-electrically conductive, transparent UV sensitive material that is able to withstand long exposures to different weather conditions.

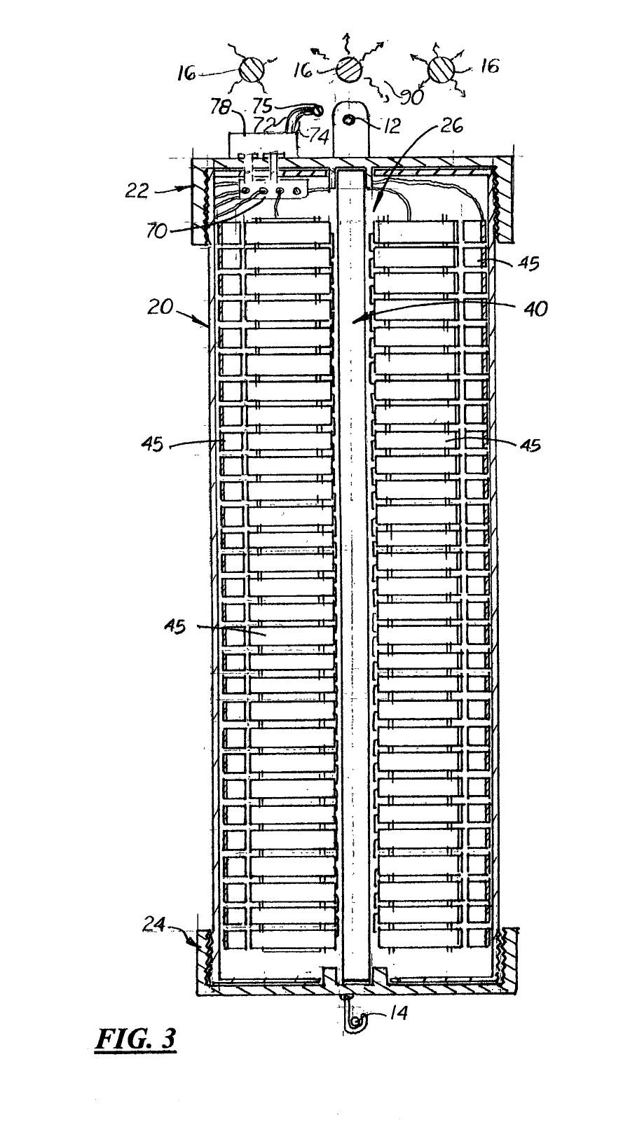

As shown in FIG. 3, disposed longitudinally inside the inner cavity 26 of the body 20 is a fully extending phosphorescent tube 40, similar to a standard fluorescent tube, designed to undergo phosphorescence 92 when placed in close proximity to the magnetic flux 90 created by an alternating electric current flowing in the high power transmission line 16. When the body 20 is assembled and hung between the upper and lower guide lines 12, 14, the phosphorescent tube 40 located inside the body 20 is in close proximity to the high power transmission line 16, so that the magnetic flux 90 created by the electric current transmitted through the high power transmission line 16 causes phosphorescence 92 in the phosphorescent tube 40.

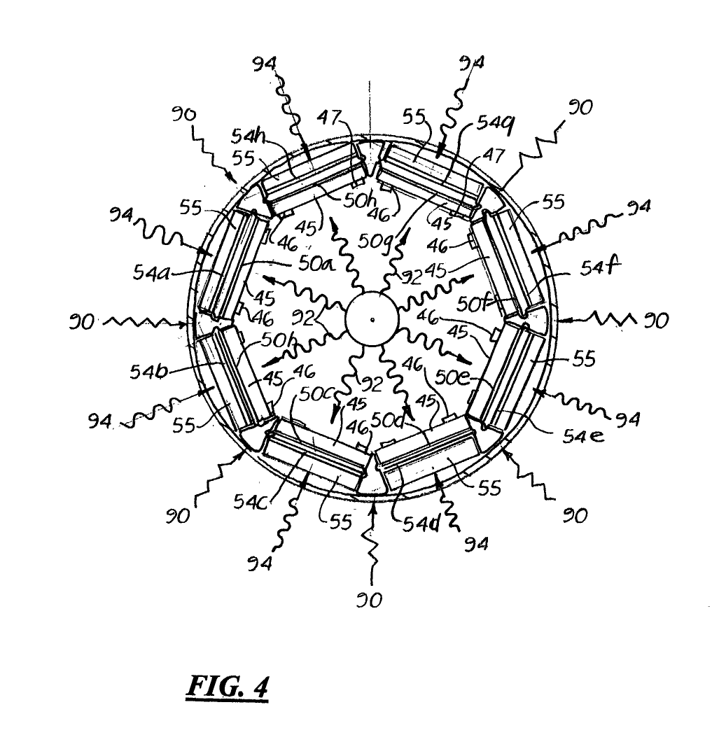

Disposed inside the cylindrical body 20 and around the phosphorescent tube 40 is a plurality of photo voltaic cells 45. In the preferred embodiment, the photo voltaic cells 45 are assembled on a removable, rectangular shaped first set of panels 50a-50h which are longitudinally and radially aligned around the phosphorescent tube 40 as shown more clearly in FIG. 4. The longitudinal edges of the first set of panels 50a-50h are aligned and registered so that panels 50a-50h form a cylindrical structure centered inside the body 20 and surround the phosphorescent tube 40. The cells 45 on panels 50a-50h face inward to capture the light energy produced by the tube 40 when exposed to the magnetic flux 90. Each photo voltaic cell 45 includes an internal transformer 46 and volt regulator 47 so that there is a constant flow of A.C. electric current. The volt regulator 47 includes a current conditioner (not shown) that conditions the electric current for photo voltaic cells 45 to match the electric current in the high power transmission line 16.

The cells 45 in one panel 50a are connected together in a series and each panel 50a 50h is connected to a main junction box 70 located in each generator 10 (see FIG. 3). Wires 72, 74 are used to connect each main junction box 70 to a supplemental collection transmission line 75. Disposed between the main junction box 70 and the collection transmission line 75 is a main voltage regulator 78 that controls the flow of energy between the generator 10 and the supplemental collection transmission line 75.

Located inside each body 20 is an optional second set of panels 54a-54h each with a plurality of photo voltaic cells 55 mounted thereon. The second set of panels 54a-54h is longitudinally aligned inside the body 20 and outside the first set of panels 50a-50h. In the preferred embodiment, the panels 54a-54h are radially aligned around the firs set of panels 50a-50h with the individual cells 55 on the second panels 54a-54h facing outward to generate electrical power from ambient light (denoted 94). The cells 55 on each second set of panels 54a-54h are connected together in a series and all of the panels 54a-54h are connected to the main junction box 70.

An optional indicator 60 may be mounted on the side of each generator 10 coupled to the photo voltaic cells 55 which informs an operator that the generator 10 is functioning properly. In the event that the generator 10 is broken or inactive, the phosphorescent tube 40 or the first and second sets of panels 50a-50h, 54a-54h, respectively, may be easily replaced or the entire generator 10 may be easily removed and replaced with another generator 10.

In the preferred embodiment, the body 20 measures approximately 96 inches in length and 20 inches in diameter. There is one phosphorescent tube 40 mounted in each generator 10. the first and second panels each have approximately 20 to 29 cells mounted thereto. Each cell measures approximately 1 inch×4 inches (W×L). In the preferred embodiment, the upper guide line 12 is spaced below the transmission line 16 six to 96 inches so that the transverse center axis of each phosphorescent tube 40 is located approximately 48 inches from the transmission line 16.

In compliance with the statute, the invention described herein has been described in language more or less specific as to structural features. It should be understood, however, that the invention is not limited to the specific features shown, since the means and construction shown, is comprised only of the preferred embodiments for putting the invention into effect. The invention is therefore claimed in any of its forms or modifications within the legitimate and valid scope of the amended claims, appropriately interpreted in accordance with the doctrine of equivalents.

I claim:

1. A supplemental electric power generator used with an electric power transmission line comprising:
a. a hollow body;
b. means to suspend said body from an electric power transmission line;
c. at least one magnetic flux induced illumination means disposed inside said body, said illumination means emitting light caused by magnetic flux generated by electricity transmitted through an electric power transmission line when placed proximate to an electric power transmission line;
d. a first panel containing a plurality of photo voltaic cells located inside said body and facing said illumination means, said photo voltaic cells producing electricity when said illumination means is activated by the flow of electricity through a nearby electric power transmission line; and,
e. means for holding said body adjacent to an electric power transmission line.

2. The supplemental electric power generator, as recited in claim 1, wherein said illumination means is a phosphorescent tube.

3. The supplemental electric power generator, as recited in claim 2, wherein said photo voltaic cells are radially aligned around said illumination means.

4. The electric power generator, as recited in claim 1, further including a set of photo voltaic cells used to produce electricity from ambient light sources.

5. The supplemental electric power generator, as recited in claim 1, wherein said body is cylindrical.

6. The supplemental electric power generator, as recited in claim 1, further including tan upper and lower end cap attached to said body.

7. The supplemental electric power generator, as recited in claim 1, wherein said first panels are aligned longitudinally inside said body.

8. The supplemental electric power generator, as recited in claim 6, wherein said means for holding said body adjacent to an electric power transmission line is a guide line aligned parallel to an electric power transmission line and a means for engaging a guide line attached on said upper end cap.

9. The supplemental electric power generator, as recited in claim 8, further including means for engaging a guide line attached to said lower end cap.

10. The supplemental electric power generator, as recited in claim 9, further including a second guide line to which said lower end cap attaches.

11. The supplemental electric power generator, as recited in claim 6, where said lower end cap is removed thereby enabling said first panel of photo voltaic cells to be easily inserted and removed from said body.

12. The supplemental electric power generator, as recited in claim 1, further including a transformer and a volt regulator.

13. A supplemental electric power generating system comprising:
a. a suspended high power transmission line used to carry a high voltage electric current;
b. a guide line suspended adjacent and parallel to said high power transmission line;
c. a plurality of supplemental electric power generators including a hollow body with at least one magnetic flux induced illumination means that illuminates when exposed to the magnetic flux created in said high power transmission line, and a plurality of photo voltaic cells located inside said body and around said illumination means to produce electricity when said illumination means is illuminated; and,
d. means to collect the electricity produced by said photo voltaic cells.

14. The supplemental electric power generator system, as recited in claim 13, wherein said illumination means in each said generator is a phosphorescent tube.

15. The supplemental electric power generator system, as recited in claim 14, wherein said photo voltaic cells in each said generator are longitudinally aligned inside said body and radially aligned around said illumination means.

16. The supplemental electric power generator system, as recited in claim 15, wherein said photo voltaic cells are mounted on panels are aligned longitudinally inside said body and radially disposed around said illumination means.

17. The supplemental electric power generator system, as recited in claim 16, wherein said body includes a removable lower end cap that enables said first panel of photo voltaic cells to be easily inserted and removed from said body.

18. The supplemental electric power generator system, as recited in claim 13, further including a transformer and a volt regulator coupled to said generator.

19. The supplemental electric power generator, as recited in claim 13, wherein each said generator further includes said body being made of transparent material and including a second set of panels with photo voltaic cells mounted thereon and located inside said body, said second set of panels being aligned inside said body so that said photo voltaic cells facing outward to be activated by ambient light.

20. The supplemental electric power generator system, as recited in claim 13, wherein each said generator includes a second guide line used to support the lower end of said body.
